(19) United States
(12) Patent Application Publication
(10) Pub. No.: US 2014/0063072 A1
(43) Pub. Date: Mar. 6, 2014

(54) INFORMATION PROCESSING APPARATUS, INFORMATION PROCESSING METHOD, AND INFORMATION PROCESSING PROGRAM

(71) Applicant: Sony Corporation, Tokyo (JP)

(72) Inventors: Hiroshi Yamaguchi, Tokyo (JP); Kenji Yamane, Kanagawa (JP); Masahiro Takahashi, Kanagawa (JP)

(73) Assignee: SONY CORPORATION, Tokyo (JP)

(21) Appl. No.: 13/958,911

(22) Filed: Aug. 5, 2013

(30) Foreign Application Priority Data
Aug. 29, 2012 (JP) 2012-188749

(51) Int. Cl. G06T 3/00

(52) U.S. Cl. CPC G06T 3/00
USPC 345/672

(57) ABSTRACT

An information processing apparatus includes a display processing unit, a setting unit, and an automatic shifting unit. The display processing unit is configured to display, on a display unit, at least a part of a pathological image as a display area. The setting unit is configured to receive, as information necessary to move the display area so as to scan the pathological image, at least information on a position of the display area in the pathological image and information on a method of moving the display area, which are set by a user. The automatic shifting unit is configured to sequentially move the display area based on the set information.

### BACKGROUND

The present disclosure relates to an information processing apparatus controlling display of an image obtained by a microscope in fields such as medicine, pathology, biology, and material, an information processing method, and an information processing program.

In the fields such as medicine and pathology, a system in which an image of a cell, a tissue, an organ, or the like of a living body, which is obtained by an optical microscope, is digitized, and a doctor, a pathologist, or the like examines the tissue or the like, or diagnoses a patient based on the digital image thus obtained, has been proposed.

For example, in the method disclosed in Japanese Patent Application Laid-open No. 2009-037250, an image, which is optically obtained by a microscope, is digitized by a video camera on which a Charge Coupled Device (CCD) is mounted, and the digital signal is input to a control computer system and is visualized on a monitor. A pathologist performs examination or the like while viewing the image displayed on the monitor (see, for example, paragraphs [0027] and [0028], and FIG. 5 of Japanese Patent Application Laid-open No. 2009-037250). Such a system is generally called a virtual microscope, and an image being examined is called a virtual slide.

It should be noted that as a technique to aid image diagnosis, for example, in Japanese Unexamined Patent Application Publication No. 2000-501184, an apparatus in which a sample is scanned at a low magnification, an abnormal cell is automatically extracted based on the shape of the core, an area including the extracted cell is photographed at a high magnification, the image is stored, and thus a pathologist or the like can evaluate the extracted abnormal cell based on the image, is disclosed.

Moreover, in Japanese Unexamined Patent Application Publication No. 2004-517349, an apparatus in which an X-Y coordinate pair of an abnormal cell automatically extracted by scanning a sample is stored, and the abnormal cell can be examined by reproducing the coordinate pair under a microscope provided with an electric stage, is disclosed.

### SUMMARY

Incidentally, in the existing virtual microscope disclosed in Japanese Patent Application Laid-open No. 2009-037250, in the case where a user moves a display range of an image or zooms in/out an image, the user needs to repeat the operation of dragging a mouse or rotating a wheel, for example.

However, a virtual slide image used by the virtual microscope is, for example, an image having a large size of 50×50 Kpixel, and it has been a formidable task for the user to thoroughly examine such an image.

In the case where a user performs diagnosis by using the existing virtual microscope, the user needs to operate an input apparatus such as a mouse and a controller, and to thoroughly examine the high-definition image. In this case, although the degree of freedom of the operation is high, it needs to perform a similar operation for each image, which takes time and trouble.

In particular, because a pathologist performs such an operation all day long, a burdensome operation makes him/her stressful, and a change in a pathological tissue expected to be found may be missed, which results in a misdiagnosis.

In view of the circumstances as described above, it is desirable to provide an information processing apparatus capable of making the examination more efficient by reducing a user's operation burden necessary to move the display range of an image in a virtual microscope, an information processing method, and an information processing program.

(1) According to an embodiment of the present disclosure, there is provided an information processing apparatus including a display processing unit configured to display, on a display unit, at least a part of a pathological image as a display area, a setting unit configured to receive, as information necessary to move the display area so as to scan the pathological image, at least information on a position of the display area in the pathological image and information on a method of moving the display area, which are set by a user, and an automatic shifting unit configured to sequentially move the display area based on the set information.

In the present disclosure, based on the position of the display area displayed on the display unit, which is received by the setting unit, and the method of moving the display area so as to scan the pathological image, the automatic shifting unit automatically and sequentially moves the display area. Therefore, when the user examines the pathological image, pathological images are automatically and sequentially displayed on the display unit even if he/she does not perform any operation. As a result, it is possible to make the examination more efficient by reducing a user's operation burden necessary to move the display range of an image in a virtual microscope.

(2) According to an embodiment of the present disclosure, there is provided an information processing apparatus further including a switching unit configured to switch between display of the pathological image in the display area sequentially moved by the automatic shifting unit and display of the pathological image in the display area selected by the user from the entire pathological image, in response to an instruction from the user.

In the present disclosure, an automatic examination mode in which the automatic shifting unit automatically and sequentially moves the display area, thereby displaying the pathological image, and a manual examination mode in which the user selects the position of the display area in the entire pathological image, thereby displaying the pathological image, are used while being appropriately switched. Accordingly, the user can examine the pathological image while optimally combining the automatic examination mode and the manual examination mode.

(3) According to an embodiment of the present disclosure, there is provided an information processing apparatus further including a generation unit configured to receive, from the user, selection of at least one pathological image corresponding to the display area, the display area being sequentially moved by the automatic shifting unit, and to generate, as scene information, information necessary to display the selected at least one pathological image, and a reproducing unit configured to display, on the display unit, the at least one pathological image based on the scene information, the at least one pathological image being selected by the user.

In the present disclosure, when the user performs a specific operation on the pathological images, which are sequentially displayed on the display unit, information necessary to again display, on the display unit, the pathological image being displayed at the time of the operation is generated as scene information. The reproducing unit reproduces the image display using the scene information so that the user causes the display unit to again display the pathological image that has been displayed at the time of the operation. Accordingly, the user can cause the information processing apparatus to store the image automatically displayed by the automatic shifting unit, and to read the image later so that the user can examine the read image. Therefore, it is possible to make the examination more efficient.

(4) According to an embodiment of the present disclosure, there is provided an information processing apparatus further comprising a path determination unit configured to determine a path for the automatic shifting unit to sequentially move the display area.

In the present disclosure, since the path determination unit calculates and determines the path for sequentially moving the display area, it is possible to prevent the user from missing an image, which is likely to be caused when the display area is moved by the user's selection.

(5) According to an embodiment of the present disclosure, there is provided an information processing apparatus in which the pathological image may be obtained by photographing a glass slide on which a sample is placed, and the path determination unit may be configured to obtain a presence map having probabilities that the sample is present, for respective areas being obtained by spatially dividing the pathological image, and to determine a path for moving the display area using the presence map.

In the present disclosure, the image of the glass slide on which the sample is placed is divided into a plurality of areas, and the presence map having probabilities that the sample is photographed (present), which are represented by a numerical value, for the respective areas, by image recognition or the like is used to determine the path for moving the display area. Accordingly, the information processing apparatus according to an embodiment of the present disclosure is capable of automatically displaying only an area in which the sample is photographed in the pathological image.

(6) According to an embodiment of the present disclosure, there is provided an information processing apparatus in which the path determination unit may be configured to receive, from the user, a designation of a range in which the automatic shifting unit sequentially moves the display area, and to determine a path for moving the display area within the designated range.

In the present disclosure, the path is determined so that the display area is moved within the area explicitly designated by the user. Accordingly, it is possible to make the examination of the pathological image more efficient by eliminating the display of the area that is considered unnecessary by the user.

(7) According to an embodiment of the present disclosure, there is provided an information processing apparatus in which the path determination unit may be configured to recognize an edge of a sample in the pathological image, and to determine a path along the edge.

In the present disclosure, since the display area is moved along the edge of the sample recognized by image recognition or the like, it is possible to make the examination of the pathological image more efficient without bothering the user, even if the edge of the sample has a complicated shape.

(8) According to an embodiment of the present disclosure, there is provided an information processing method including displaying, by a display processing unit, on a display unit, at least a part of a pathological image as a display area, receiving, by a setting unit, as information necessary to move the display area so as to scan the pathological image, at least information on a position of the display area in the pathological image and information on a method of moving the display area, which are set by a user, and sequentially moving, by an automatic shifting unit, the display area based on the set information.

(9) According to an embodiment of the present disclosure, there is provided an information processing program that causes a computer to function as a display processing unit configured to display, on a display unit, at least a part of a pathological image as a display area, a setting unit configured to receive, as information necessary to move the display area so as to scan the pathological image, at least information on a position of the display area in the pathological image and information on a method of moving the display area, which are set by a user, and an automatic shifting unit configured to sequentially move the display area based on the set information.

As described above, according to the present disclosure, it is possible to make the examination of an image in a virtual microscope more efficient.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing an example of displaying a virtual slide based on a method of performing display by gradually and smoothly moving a part of the virtual slide displayed in a display area of a viewer by a panning operation and scanning the entire virtual slide;

FIG. 2 is a diagram showing another example of displaying the virtual slide based on the method of displaying by gradually and smoothly moving the part of the virtual slide displayed in the display area of the viewer by the panning operation and scanning the entire virtual slide;

FIG. 3 is a diagram showing still another example of displaying the virtual slide based on the method of displaying by gradually and smoothly moving the part of the virtual slide displayed in the display area of the viewer by the panning operation and scanning the entire virtual slide;

FIG. 4 is a diagram showing an example of a presence map M;

FIG. 5 is a diagram showing a state of scanning only an area in which a sample is present as the display area of the viewer;

FIG. 6 is a diagram showing a state of performing scanning by automatic examination within the range selected by a user in advance on a map representing the entire virtual slide before starting an automatic examination mode;

FIG. 7 is a diagram showing a state of examining only an edge of the sample in the automatic examination mode;

FIG. 8 is a diagram showing a state in which the user has performed an instruction operation to move the display area to the lower direction two times while the viewer performs scanning from the left to right direction;

FIG. 9 is a diagram showing a state in which when the display area of the viewer is moved to the edge of the sample and the user tries to move the display area further to the right direction or to the lower direction, the viewer has adjusted the movement direction to the lower left;

FIG. 10 is a diagram showing a typical usage environment of a viewer 500 according to an embodiment of the present disclosure;

FIG. 11 is a block diagram showing a hardware configuration of the viewer 500 according to this embodiment;

FIG. 12 is a diagram showing functional blocks of a digital pathological server 400;

FIG. 13 is a diagram showing functional blocks of the viewer 500;

FIG. 14 is a flowchart showing the entire flow of the processing performed by the viewer 500;

FIG. 15 is a flowchart showing the flow of the processing at the time when a specific scene is selected;

FIG. 16 is a flowchart showing the flow of the processing related to the automatic examination mode; and

FIG. 17 is a flowchart showing the flow of the processing related to the limitation of the range of the automatic examination mode.

### DETAILED DESCRIPTION OF EMBODIMENTS

Hereinafter, embodiments according to the present disclosure will be described with reference to the drawings.

### First Embodiment

### [Regarding Overview of Present Disclosure]

When a user (pathologist) examines a virtual slide, he/she normally performs, mainly, panning and zooming operations on a viewer. In the present disclosure, a part of the operations is automatically performed to reduce the user's burden.

In the present disclosure, in addition to a manual examination mode in which the viewer performs panning or zooming operations and changes the display of the virtual slide in response to any operation performed by the user, an automatic examination mode is provided. In the automatic examination mode, because the viewer automatically switches the image display, the user can focus on the diagnosis more than the operation. Moreover, in the automatic examination mode, because the entire sample in the virtual slide is thoroughly displayed, it is possible to prevent the user from missing a part of the image.

It should be noted that in the following, although the terms “automatic examination mode” and “manual examination mode” are used, they are also referred to as “automatic viewing mode” and “manual viewing mode,” respectively.

### [Regarding Image Diagnosis Method in Present Disclosure]

In diagnosis using a microscope, e.g., cytologic diagnosis, diagnosis is performed as follows. First, an examiner searches for a malignant cell or an abnormal cell by screening of the entire sample using a relatively low power objective lens (e.g., 10×).

Here, in the case where a suspected cell is found, in order to examine the structure of the cell in more detail, the objective lens is replaced with a high power one (e.g., 40×), the cell is examined in detail while the focal position is changed, and thus whether or not the cell is a desired cell is determined.

As described above, as an image diagnosis method, there is a diagnosis method in which after the entire virtual slide is examined in image display at a low magnification, a part of the virtual slide, which is desired to be confirmed in detail, is displayed at a high magnification and is examined in detail.

The present disclosure supports making such a diagnosis method more efficient. Specifically, by automating the display at the time when the entire virtual slide is examined in image display at a low magnification, the user's burden of performing a panning operation is reduced, and missing of an image is prevented.

### [Regarding Display Method in Automatic Examination Mode]

There are two methods of displaying a virtual slide in an automatic examination mode. In the first display method, display is performed by gradually and smoothly moving a part of the virtual slide displayed in a display area of a viewer by a panning operation and scanning the entire virtual slide.

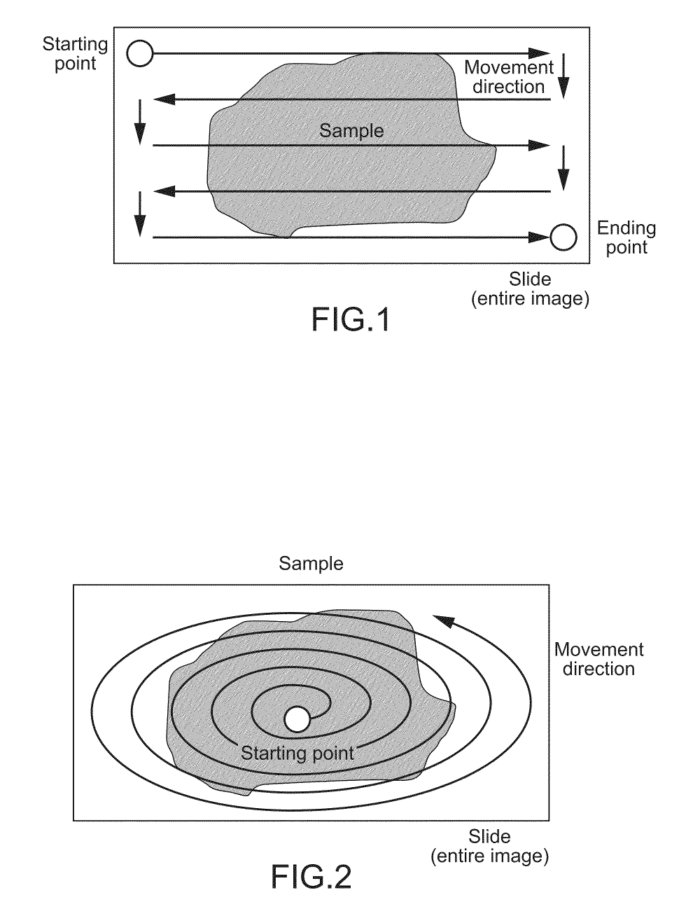

FIG. 1 is a diagram showing an example in which the viewer displays the virtual slide based on the method. FIG. 1 shows a state in which the display area is located at the upper left end of the virtual slide at first, then moved to the right end, and slightly moved to the lower direction when it arrives at the right end before it is moved to the left end, thereby scanning the entire image.

FIG. 2 is also a diagram showing an example in which the viewer displays the virtual slide based on the method. In FIG. 2, the display area is located at the center position of the virtual slide at first, and is helically moved in a counterclockwise direction.

In the second method of displaying a virtual slide in an automatic examination mode, the entire image of the virtual slide, which has resolution corresponding to the display magnification selected by a user, is divided by the size of the display area of the viewer, and the respective images obtained by the division are sequentially switched and displayed.

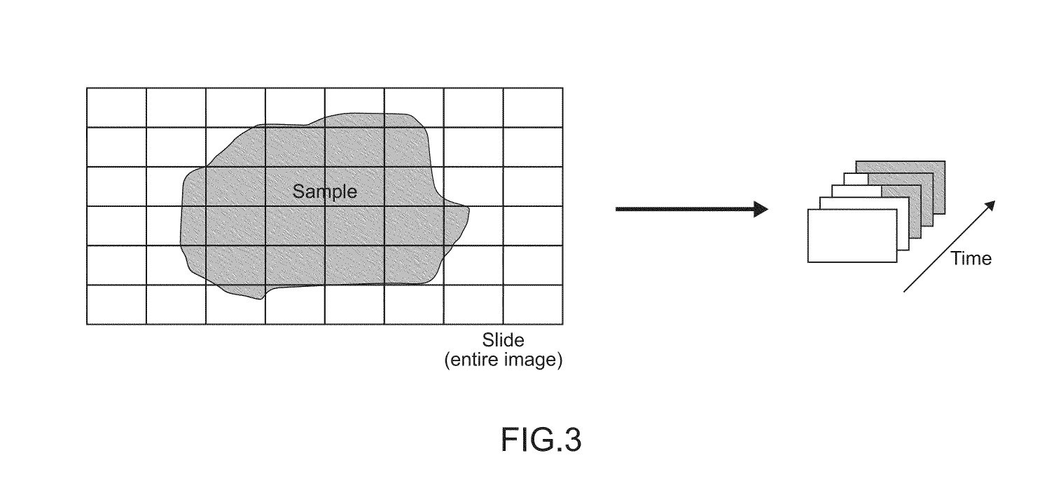

FIG. 3 is also a diagram showing an example in which the viewer displays the virtual slide based on the method. The left side of FIG. 3 shows a state in which the entire virtual slide is divided so as to match the size of the display area of the viewer. The right side of FIG. 3 shows a state in which images obtained by dividing the virtual slide so as to match the size of the display area of the viewer are sequentially switched and displayed from, for example, the image located at the upper left end to images in the right side direction, with the passage of time.

[Regarding Switching between Automatic Examination Mode and Manual Examination Mode]

When examining the virtual slide using the viewer, the user can freely switch between the automatic examination mode and the manual examination mode. For example, when the user examines the virtual slide in the manual examination mode, the automatic examination mode is started by selecting the automatic examination mode from the pull-down menu. Moreover, when the viewer is in the automatic examination mode and the user performs a zooming operation, for example, the automatic examination mode is temporarily released, and the zooming operation is performed in the manual examination mode. Switching between the automatic examination mode and the manual examination mode is described in detail in the description of the entire flow of the processing to be described later.

### [Regarding Items Set in Automatic Examination Mode]

The user needs to set items for designating a display operation performed by the viewer in the automatic examination mode before the automatic examination mode is started. The items are as follows.

(1) Display magnification (magnification for displaying the virtual slide in the display area of the viewer in the automatic examination mode, e.g., any one of magnifications of 1 to 40×)

(2) Display starting point (designation of the position of the virtual slide to be displayed in the display area of the viewer at first, e.g., upper left, lower left, upper right, and lower right of the slide, and the center of the image)

(3) Scanning direction (direction in which the display area of the viewer is moved on the virtual slide, e.g., from the upper left to the lower right, from the upper right to the lower left, from the lower left to the upper right, from the lower right to the upper left, of the slide, from the center portion helically in a clockwise direction, and from the center portion helically in a counterclockwise direction)

(4) Display switching method (method of switching display in the automatic examination mode, e.g., method of gradually moving the display range in the scanning direction, and method of switching and displaying images obtained by the division, as described above)

(5) Switching rate of display or moving rate of display (e.g., specification of moving the display area of the viewer at a rate of x mm per y second(s) (x[mm]/y[s]), or specification of displaying z frames per second (z[fps]))

(6) Using presence map (to be described later) (e.g., a presence map is used to determine the path for moving the display area of the viewer on the virtual slide)

It should be noted that the above-mentioned items may be set in advance, or may be set when the user starts the automatic examination mode.

Moreover, the viewer may be configured to learn a plurality of operations performed by a user or a plurality of users in the manual examination mode, to store values frequently used for the above-mentioned items, or the optimal value, and to automatically set the values in the automatic examination mode.

### [Regarding Presence Map]

A presence map is originally made for determining, when a glass slide on which a sample is placed is photographed to create a virtual slide, which portion of the glass slide is photographed by a microscope. In the presence map, an image obtained by the macro photography of the glass slide on which the sample is placed is divided into a plurality of areas, and whether or not the sample is photographed in the respective areas is determined by image recognition or the like to digitize the result.

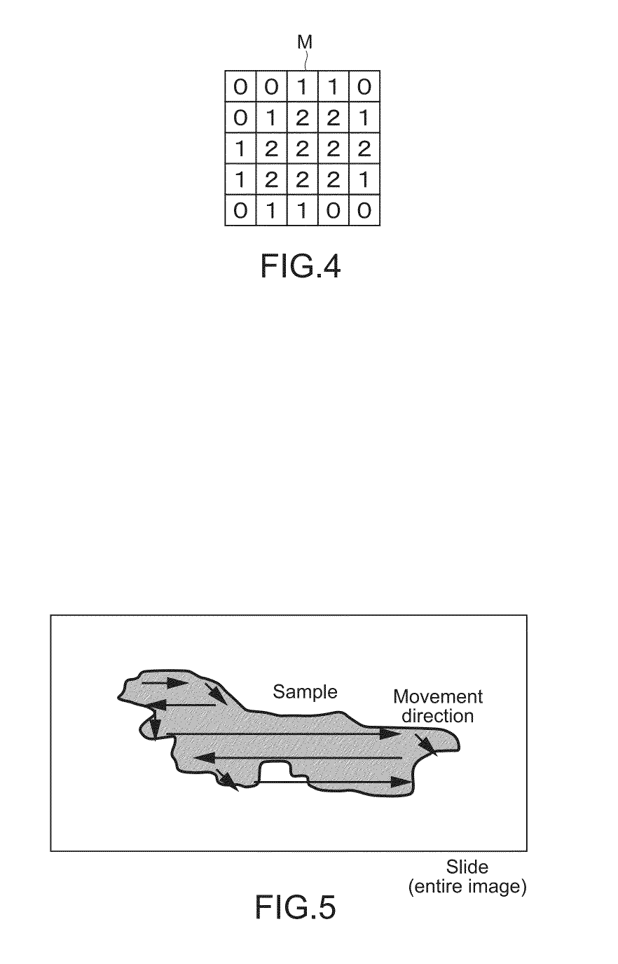

FIG. 4 is a diagram showing an example of a presence map M. In FIG. 4, an image obtained by the macro photography is equally divided into 25 areas, and a number from 0 to 2 is assigned to each area. Zero represents that the probability of the presence of the sample in the area is the lowest, 2 represents that the probability of the presence of the sample in the area is the highest, and 1 represents that the probability of the presence of the sample in the area is between these probabilities.

Because the presence map provides information related to which portion of the image of the virtual slide the sample is photographed, it is possible to display only an area in which the sample is photographed by using the presence map when the virtual slide is displayed in the automatic examination mode, as described above.

### [Regarding Setting of Scene]

In a diagnosis method in which after the entire virtual slide is examined at a low magnification, a part of the slide of concern is examined at a high magnification, the automatic examination mode automates the operation of examining the entire virtual slide at a low magnification, as described above. If there is a part of concern during the examination at a low magnification, it is convenient to store the part, and to immediately examine the part during the examination at a high magnification later.

In the present disclosure, in the case where the user finds a part of concern during the examination in the automatic examination mode, it is possible by performing a specific operation to store the part as a scene and to easily jump to the scene when switching to the manual examination mode later. As an internal operation, the viewer stores the coordinate position and display magnification of the scene when storing the part as a scene, and reproduces the scene based on the stored coordinate position and display magnification when jumping to the scene.

It should be noted that the viewer may be configured to be able to store a plurality of scenes with respect to one virtual slide. Accordingly, the user can select a desired scene from the plurality of scenes and jump to the desired scene after switching to the manual examination mode.

### [Regarding Application of Scene]

In the above-mentioned setting of a scene, the scene stored in the automatic examination mode is used after switching to the manual examination mode. A similar idea can be used when returning from the manual examination mode to the automatic examination mode.

In the case where a part of concern is found during the examination in the automatic examination mode and the part is desired to be immediately examined in detail, if the user performs a zooming operation or the like, the automatic examination mode is switched to the manual examination mode and the viewer stores the state (coordinate position and items set in the automatic examination mode) at the time when the automatic examination mode is stopped. If switching to the automatic examination mode is performed after the user performs the examination in the manual examination mode, the viewer reproduces the display at the time when the automatic examination mode is stopped based on the stored state at the time when the automatic examination mode is stopped, and the automatic examination mode is resumed from the time when the automatic examination mode is stopped.

[Regarding Effective Use of Automatic Examination Mode (Combined with Presence Map)]

Now, a method of more effectively using the function of the automatic examination mode will be described.

First, the automatic examination mode combined with the presence map will be described. By using the presence map, if the area in which the sample is present can be known in the entire image of the virtual slide, the viewer only needs to display only the area as the display area. Accordingly, it is possible to make the automatic examination more efficient. FIG. 5 is a diagram showing a state of scanning only an area in which the sample is present as the display area of the viewer.

### [Regarding Effective Use of Automatic Examination Mode (Designation of Area by User)]

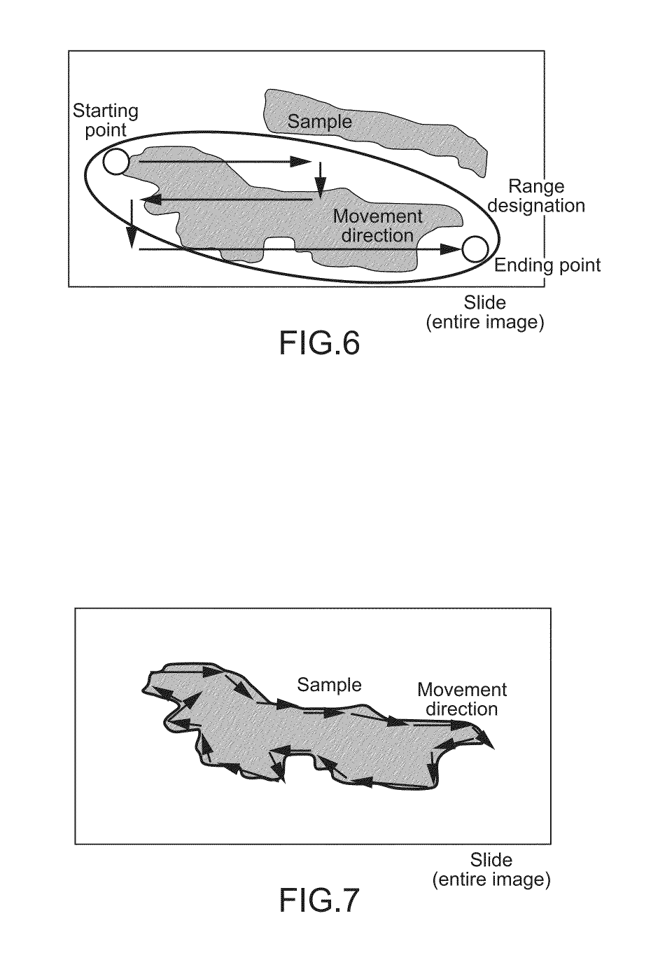

In the above-mentioned configuration, information on the area in which the sample is present in the image of the virtual slide is provided by the presence map. However, instead of using the presence map, the user may designate the area to be scanned by the viewer. FIG. 6 is a diagram showing a state of performing scanning by automatic examination within the range selected by a user in advance on a map representing the entire virtual slide before starting an automatic examination mode. With this configuration, the user can explicitly exclude an area that clearly needs not to be examined from the scanning target.

[Regarding Effective Use of Automatic Examination Mode (Combined with Another System)]

The automatic examination mode may be used combined with another system. For example, in cooperation with the medical diagnosis support system disclosed in Japanese Unexamined Patent Application Publication No. 2000-501184 or Japanese Unexamined Patent Application Publication No. 2004-517349, a part expected to be examined may be presented by the system, and it may be possible to automatically examine only the part as a target. Moreover, the examination target is not limited to the part, and it may be possible to preferentially examine the part and to examine another part after the preferential examination.

On the contrary, a part presented by the combined system may be examined in the manual examination mode at first, and only an area that has not been examined may be examined as a target in the automatic examination mode.

### [Regarding Effective Use of Automatic Examination Mode (Examination of Edge of Sample as Target)]

Only a portion of an edge of the sample in the virtual slide may be extracted by image recognition, and only the edge may be automatically examined. Moreover, the examination target is not limited to the edge, the edge may be preferentially and automatically examined, and after that another area may be automatically examined. FIG. 7 is a diagram showing a state of examining only the edge of the sample in the automatic examination mode.

It should be noted that a method of scanning by automatic examination may be changed depending on the part of the sample or the case, e.g., the edge of the sample is preferentially and automatically examined in the case of stomach cancer.

### [Regarding Complementary Use of Automatic Examination Mode (Aid in User's Operation)]

The function of the automatic examination mode can be used as an aid in the user's operation.

In the above description, scanning in which the display area of the viewer is moved on the virtual slide in the automatic examination mode is performed alternately in the lateral direction of the slide and after that in the vertical direction of the slide, thereby scanning the entire slide, in the case of FIG. 1, for example.

However, here, because the automatic examination mode is used as an aid in the user's operation, for example, only scanning in the lateral direction of the slide may be performed in the automatic examination mode. In this case, the user performs an operation in the vertical direction. Because the user's operation can be received even in the automatic examination mode, it is possible to increase the degree of freedom associated with the display of the image of the virtual slide for the user. Moreover, because the viewer performs scanning in the lateral direction, it is possible to reduce the user's burden of operation, as compared to the manual examination mode.

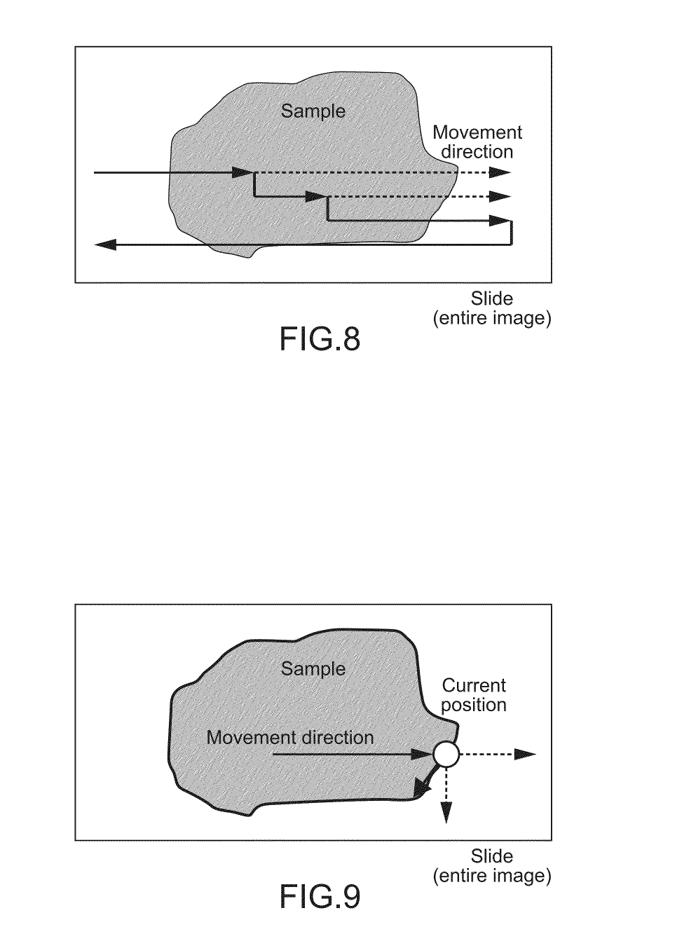

FIG. 8 is a diagram showing a state in which the user has performed an instruction operation to move the display area to the lower direction two times while the viewer performs scanning from the left to right direction.

As shown in FIG. 8, the user performs an operation, which may generate an area that is not displayed. In this case, after a series of automatic examination is completed, only the area that has not been displayed may be subsequently displayed.

[Regarding Complementary Use of Automatic Examination Mode (Improvement in Convenience of User's operation)]

In the above example, although the automatic examination mode is used as an aid in the user's operation, when the user examines the virtual slide in the manual examination mode, the user's operation may be guided to improve the convenience for the user, similarly.

FIG. 9 is a diagram showing a state in which when the display area of the viewer is moved to the edge of the sample and the user tries to move the display area further to the right direction or to the lower direction, the viewer has adjusted the movement direction to the lower left.

As shown in FIG. 9, in the case where when the viewer displays the edge of the sample, the viewer has information on the area in which the sample is present, which is obtained from, for example, a presence map, or knows that no sample is present in the direction operated by the user (right or downward), the viewer limits the movement to the direction. Moreover, the viewer adjusts the movement direction of the display area from the downward to the lower left. The viewer supports such user's operation, which improves the operability at the time when the virtual slide is examined using the viewer.

### [Dynamic Change of Setting Values During Examination in Automatic Examination Mode]

In the above description, although various setting values related to the automatic examination mode are set before the automatic examination mode is started the values may be dynamically changed during examination in the automatic examination mode. With this configuration, it is possible to perform examination with higher degree of freedom during examination in the automatic examination mode.

For example, if a specific operation is performed during examination in the automatic examination mode, the moving or switching rate of display can be accelerated or slowed.

### [Generation or Change of Setting Values by Learning]

In the above described configuration, the setting values for the automatic examination mode are explicitly set by the user before or when the automatic examination mode is started, or the setting values are explicitly changed by the user during examination in the automatic examination mode. Instead of the configuration, the viewer may learn the user's operation in the manual examination mode, and the setting values for the automatic examination mode may be set or updated based on what is learned. According to the configuration, it is possible to reduce the user's burden of explicitly setting the setting values for the automatic examination mode.

### [Regarding Usage Environment of Viewer]

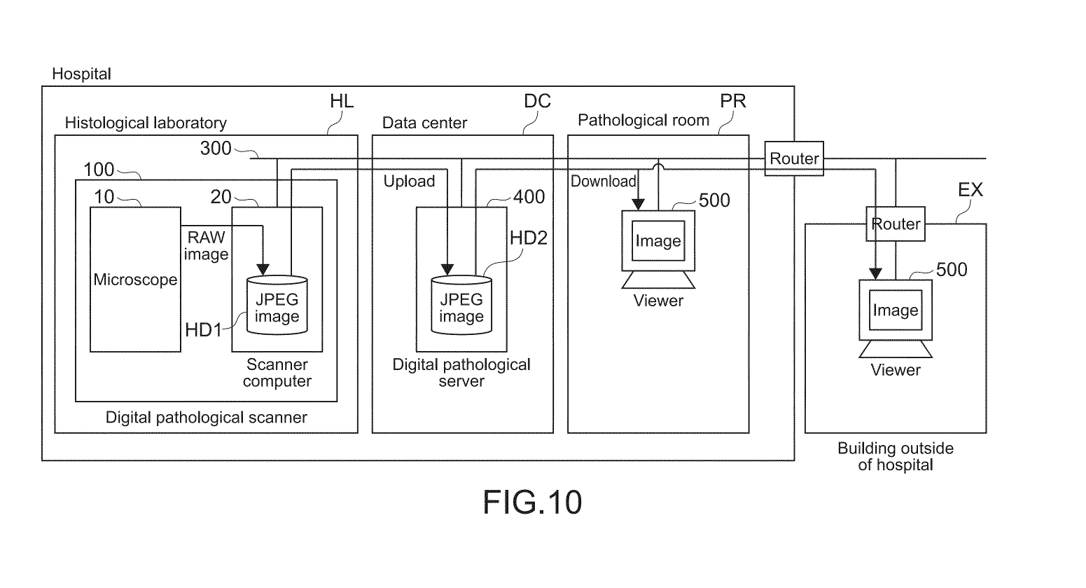

The whole picture of an environment in which a pathologist performs diagnosis using a virtual slide (pathological image) obtained by photographing a sample by a microscope in pathological diagnosis will be described. The pathologist examines the virtual slide using a viewer and performs image diagnosis. FIG. 10 is a diagram showing a typical usage environment of the viewer 500 according to an embodiment of the present disclosure.

A digital pathological scanner 100 including a microscope 10 and a scanner computer 20 is installed in a histological laboratory HL in a hospital. The microscope 10 takes a RAW image. The scanner computer 20 processes the RAW image. Examples of the image processing include processing procedure, shading processing, color balance correction, gamma correction, and 8-bit processing. After that, the processed image is divided into tiles. The size of the tiles is, for example, 256 pixels×256 pixels. The image divided into tiles is converted into a JPEG (Joint Photographic Experts Group) image, and is compressed. After that, the compressed image is stored in a hard disk HD1.

The hard disk HD1 of the scanner computer 20 stores the JPEG image. Next, the JPEG image is uploaded to a hard disk HD2 through a network 300. The hard disk HD2 is in the digital pathological server 400. The digital pathological server 400 is in a data center DC in the same hospital.

A pathologist being an observer is in a pathological room PR in the hospital or in a building EX outside of the hospital. The pathologist examines a JPEG image stored in the hard disk HD2 of the digital pathological server 400 by using the viewer 500. The viewer 500 is connected to the digital pathological server 400 through the network 300.

Alternatively, a pathologist being an observer instructs the viewer 500 to record, as a scene, an image displayed on a screen of the viewer.

### [Regarding Configuration of Viewer 500]

Next, a hardware configuration of the viewer 500 will be described.

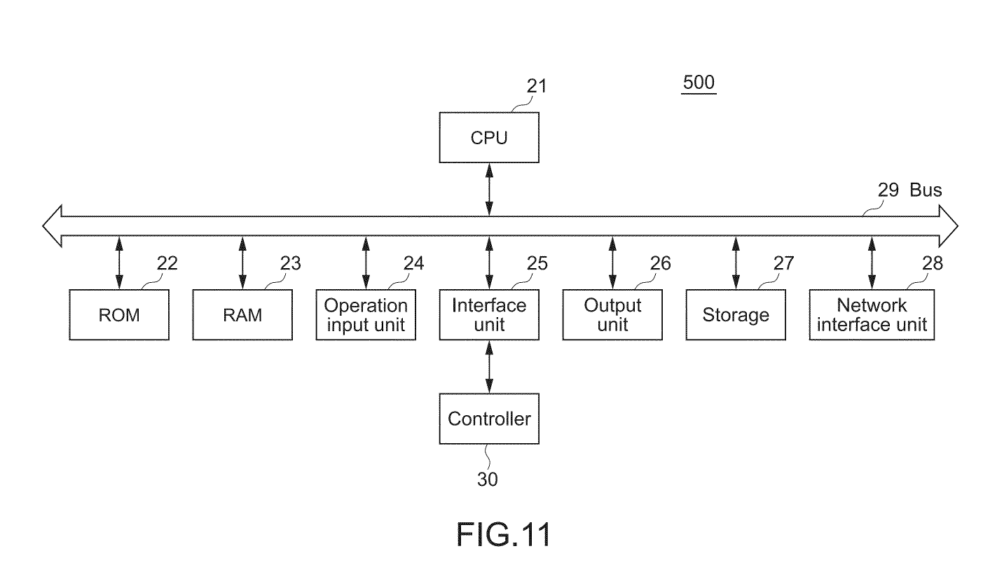

FIG. 11 is a block diagram showing the hardware configuration of the viewer 500 according to this embodiment.

The viewer 500 includes a CPU (Central Processing Unit) 21, a ROM (Read Only Memory) 22, a RAM (Random Access Memory) 23, and an operation input unit 24. The CPU 21 performs arithmetic control. The RAM 23 is a work memory for the CPU 21. Instructions depending on operation by a user are input in the operation input unit 24. The viewer 500 further includes an interface unit 25, an output unit 26 (display unit), storage 27, a network interface unit 28, and a bus 29 connecting them.

Programs for executing various processes are stored in the ROM 22. A controller 30 is connected to the interface unit 25. The controller 30 is provided with various buttons or sticks, and can receive various inputs from the user.

Moreover, the controller 30 includes an acceleration sensor or a tilt sensor. When a user tilts or shakes the controller 30, the controller 30 can receive an instruction from the user.

The network 300 is connected to the network interface unit 28. A liquid crystal display, an EL (Electro Luminescence) display, a plasma display, or the like is applied to the output unit 26 for image display. A magnetic disk typified by an HDD (Hard Disk Drive), a semiconductor memory, an optical disk, or the like is applied to the storage 27.

The CPU 21 expands a program corresponding to an instruction from the operation input unit 24, out of a plurality of programs stored in the ROM 22, the storage 27, and the like, in the RAM 23. The CPU 21 arbitrarily controls the output unit 26 and the storage 27 based on the expanded program.

The CPU 21 implements functional blocks to be described later. The CPU 21 executes the programs stored in the ROM 22, the storage 27, and the like. The CPU 21 as necessary controls the above-mentioned units. Because of this, the viewer 500 is capable of implementing the various functional blocks. The viewer 500 is capable of causing the respective unit to function as the viewer 500.

### [Regarding Configuration of Digital Pathological Server 400]

Next, a hardware configuration of the digital pathological server 400 will be described.

The hardware configuration of the digital pathological server 400 is basically the same as the hardware configuration of the viewer 500 except that the controller 30 is not connected to the interface unit 25. In view of this, detailed description of the hardware configuration of the digital pathological server 400 is omitted.

### [Regarding Functional Blocks of Digital Pathological Server 400]

Next, the functional blocks of the digital pathological server 400 will be described. The first main function of the digital pathological server 400 is to provide a pathological image in response to a request from the viewer 500.

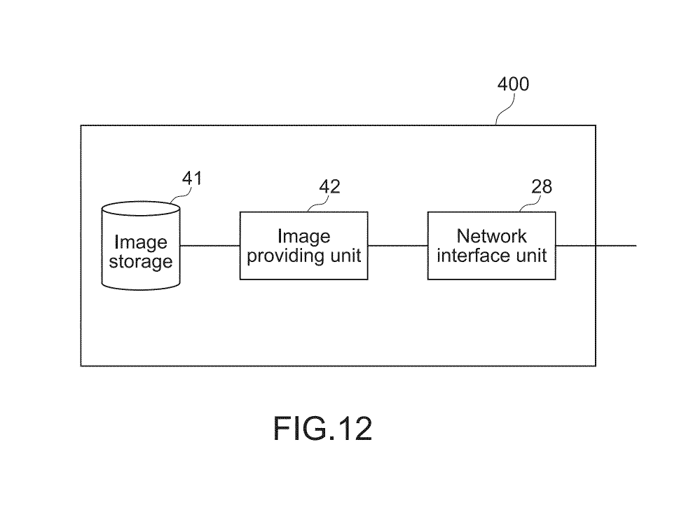

FIG. 12 is a diagram showing functional blocks of the digital pathological server 400.

The digital pathological server 400 includes the following functional blocks, i.e., image storage 41 and an image providing unit 42.

The image storage 41 stores a pathological image, which is divided into tiles and compressed in the JPEG format. The image providing unit 42 provides the stored pathological image to the viewer 500 in response to a request from the viewer 500.

The image providing unit 42 obtains, from the image storage 41, a pathological image corresponding to an image request sent from the viewer 500 through the network 300, and transmits the obtained image to the viewer 500 through the network 300.

It should be noted that because the digital pathological server 400 and the viewer 500 constitute a client-server system, determining which function is executed on the client side and which function is executed on the server side is a design item. Therefore, where the respective functional blocks are executed is not limited to the digital pathological server 400, and the respective function blocks may be executed on the viewer 500 being the client side.

### [Regarding Functional Blocks of Viewer 500]

Next, the functional blocks of the viewer 500 will be described. First, the main function of the viewer 500 is to receive an operation instruction from a user being a pathologist in the manual examination mode, to obtain the pathological image corresponding to the instruction from the digital pathological server 400, and to display the image for the user. Second, the main function of the viewer 500 is to automatically receive the pathological image from the digital pathological server 400 in the automatic examination mode and to automatically display the image for the user.

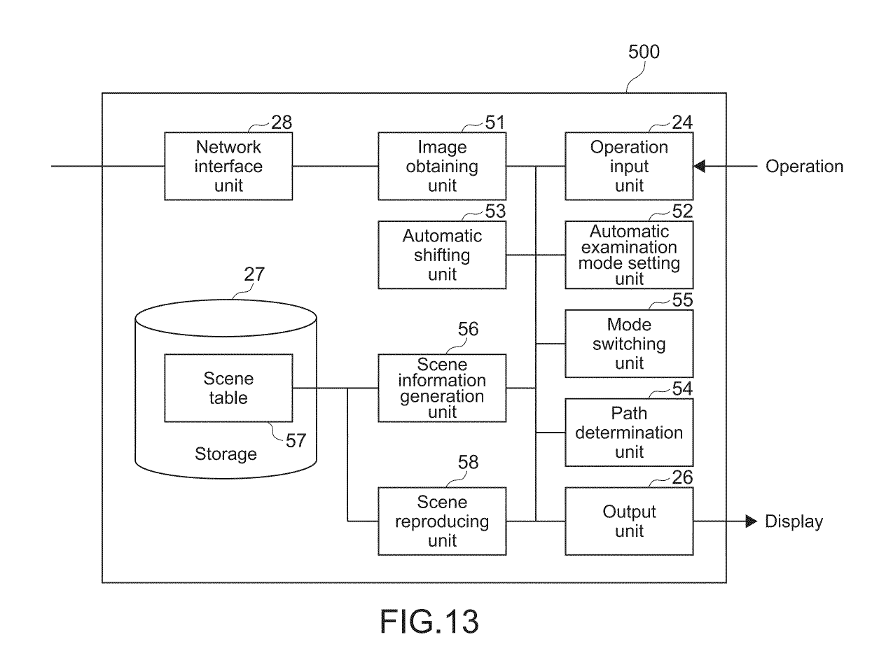

Third, the main function of the viewer 500 is to store information on the display image designated by the user as a scene, and to reproduce the stored scene in response to, for example, the instruction from the user. FIG. 13 is a diagram showing the functional blocks of the viewer 500.

The viewer 500 includes the following functional blocks, i.e., an image obtaining unit 51 (display processing unit), an automatic examination mode setting unit 52 (setting unit), an automatic shifting unit 53 (automatic shifting unit), a path determination unit 54 (path determination unit), a mode switching unit 55 (switching unit), a scene information generation unit 56 (generation unit), a scene table 57, and a scene reproducing unit 58 (reproducing unit).

The image obtaining unit 51 obtains, from the digital pathological server 400 through the network 300, a pathological image corresponding to an instruction from a user being a pathologist, which is input from the operation input unit 24 in the manual examination mode, and presents the obtained pathological image to the user via the output unit 26.

Moreover, the image obtaining unit 51 obtains, from the digital pathological server 400 through the network 300, a pathological image corresponding to an instruction from the automatic shifting unit 53 in the automatic examination mode, and presents the obtained pathological image to the user via the output unit 26.

The automatic examination mode setting unit 52 receives the setting values for the automatic examination mode set by the user via the operation input unit 24, and performs the setting. It should be noted that the setting values for the automatic examination mode may be set by the user or may be automatically set by the automatic examination mode setting unit 52, which learns the user's operation in the manual examination mode. The automatic examination mode setting unit 52 provides, to the automatic shifting unit 53, the setting values necessary for the automatic shifting unit 53 to automatically display the pathological image in the automatic examination mode.

The automatic shifting unit 53 sets the display area displayed on a screen of the viewer 500 in the entire pathological image when the viewer 500 is in the automatic examination mode, and automatically and sequentially moves the display area, thereby automatically displaying the pathological image. The setting values being parameters for performing the automatic display area provided from the automatic examination mode setting unit 52.

The path determination unit 54 determines a path for the automatic shifting unit 53 to shift and move the display area on the pathological image. The path is changed depending on the cases such as the case where the presence map is used, the case where the display range is designated by the user, and the case where only the edge of the sample is displayed.

The mode switching unit 55 switches between the automatic examination mode and the manual examination mode, in response to a specific operation of the viewer performed by the user.

The scene information generation unit 56 stores, in response to an instruction from the user input when the pathological image is presented to the user, the coordinate and display magnification of the image being presented, in the scene table 57 as scene information.

The scene table 57 receives scene information of each scene from the scene information generation unit 56 and stores it. The scene information stored in the scene table 57 is used by the scene reproducing unit 58 to reproduce each scene.

The scene reproducing unit 58 reproduces each scene based on the scene information stored in the scene table 57.

The above is a description of the functional blocks of the viewer 500. It should be noted that because the viewer 500 and the digital pathological server 400 constitute a client-server system, determining which function is executed on the client side and which function is executed on the server side is a design item. Therefore, where the respective functional blocks are executed is not limited to the viewer 500, and the respective function blocks may be executed on the digital pathological server 400 being the server side.

### [(Entire) Flow of Processing]

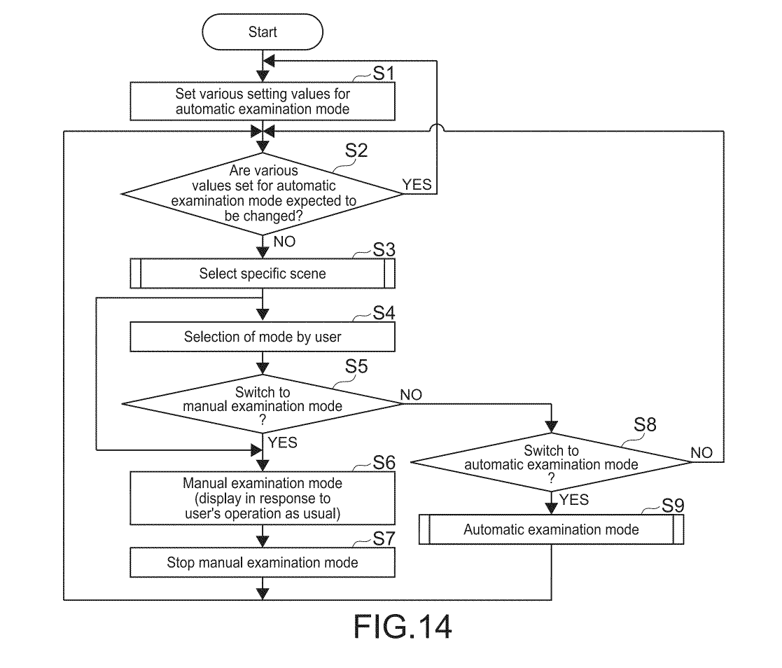

Next, the entire flow of the processing will be described. It should be noted that a part of the flow will be described later in detail. FIG. 14 is a flowchart showing the entire flow of the processing performed by the viewer 500.

First, the automatic examination mode setting unit 52 sets various setting values for the automatic examination mode (Step S1). The values for setting may be directly input by the user, or may be obtained from the automatic examination mode setting unit 52, which learns the user's operation performed in the manual examination mode.

Next, the automatic examination mode setting unit 52 confirms whether or not the values set for the automatic examination mode are expected to be changed (Step S2). In the case where the values are expected to be changed, the process returns to Step S1, and the setting values are changed.

In the case where the setting values are not expected to be changed (NO in Step S2), next, the viewer 500 selects a specific scene (Step S3). The processing of selecting the specific scene will be described later in detail. After the specific scene is selected, the user selects a mode (Step S4), or the viewer 500 starts the manual examination mode (Step S6). In the case where the user selects a mode (Step S4), the mode switching unit 55 receives a user's explicit operation and selects one of the modes of the automatic examination mode (NO in Step S5, YES in Step S8) and the manual examination mode (YES in Step S5).

In the case where the manual examination mode is selected, the viewer 500 displays a pathological image for manual examination until the examination is stopped (Step S7). Moreover, in the case where the automatic examination mode is selected, the viewer 500 starts the automatic examination mode (Step S9).

The above is the entire flow of the processing performed by the viewer 500.

### [Flow of Processing (Selection of Specific Scene)]

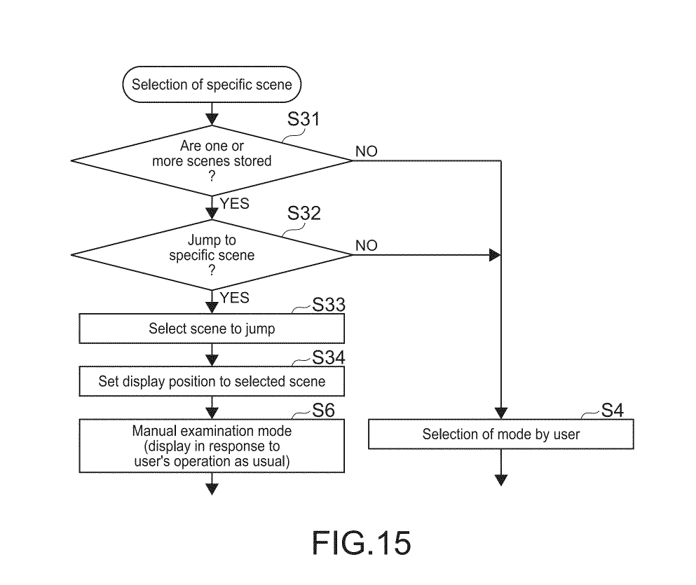

Next, the flow of the processing at the time when a specific scene is selected will be described. FIG. 15 is a flowchart showing the flow of the processing at the time when the specific scene is selected.

First, the scene reproducing unit 58 determines whether or not one or more scenes to be reproduced are stored or whether or not it jumps to the specific scene (specific scene is reproduced).

In the case where no scene is stored (NO in Step S31), or the specific scene is not reproduced (NO in Step S32), the process proceeds to the step of the selection of mode by the user (Step S4).

In the case where the specific scene is reproduced (YES in Step S31 and YES in Step S32), first, the scene reproducing unit 58 causes the user to select a scene to be reproduced (Step S33), and then sets the position of the pathological image to be displayed on the screen to the coordinate of the selected scene (Step S34).

After the specific scene is reproduced, the process performed by the viewer 500 proceeds to the step of starting the manual examination mode (Step S6).

The above is the flow of the processing related to the selection of the specific scene.

### [Flow of Processing (Automatic Examination Mode)]

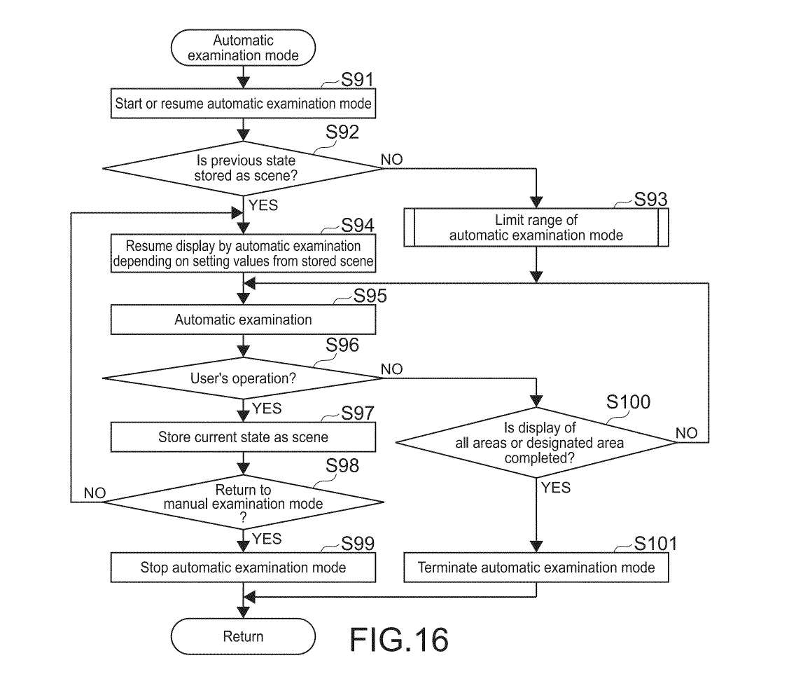

Next, the flow of the processing related to the automatic examination mode will be described. FIG. 16 is a flowchart showing the flow of the processing related to the automatic examination mode.

First, if the switching to the automatic examination mode is selected in Step S8 shown in FIG. 14 (Yes in Step S8), the processing in the automatic examination mode is started or resumed (Step S91).

In the case where the automatic examination mode is newly started, because the state at the time when the automatic examination mode is stopped last time is not stored as a scene (NO in Step S92), first, the processing of limiting the range of the automatic examination mode is started (Step S93). The processing of limiting the range of the automatic examination mode will be described later in detail.

In the case where the state at the time when the automatic examination mode is stopped last time is stored as a scene (YES in Step S92), the state is reproduced based on the scene information (Step S94).

After the processing in the case where the automatic examination mode is newly started and in the case where the automatic examination mode is resumed is completed, the automatic shifting unit 53 starts the automatic display in the automatic examination mode (Step S95).

If the display of all the areas expected to be displayed in the automatic examination mode is completed (YES in Step S100), the automatic shifting unit 53 terminates the automatic examination mode (Step S 101).

Moreover, in the case where the automatic examination mode is stopped by the specific operation performed by the user (YES in Step S96), the scene information generation unit 56 stores the current state of display as a scene (Step S97).

After that, if the user provides an instruction to return to the manual examination mode (YES in Step S98), the viewer 500 stops the automatic examination mode (Step S99).

If the user provides an instruction to not return to the manual examination mode (NO in Step S98), the process performed by the viewer 500 returns to Step S94 and the automatic examination mode is resumed from the stored state of the scene. This processing represents the above-mentioned flow of the processing of switching from the automatic examination mode to the manual examination mode temporarily and returning to the automatic examination mode after the manual examination mode is finished.

The above is the flow of the processing related to the automatic examination mode.

### [Flow of Processing (Limiting Range of Automatic Examination Mode)]

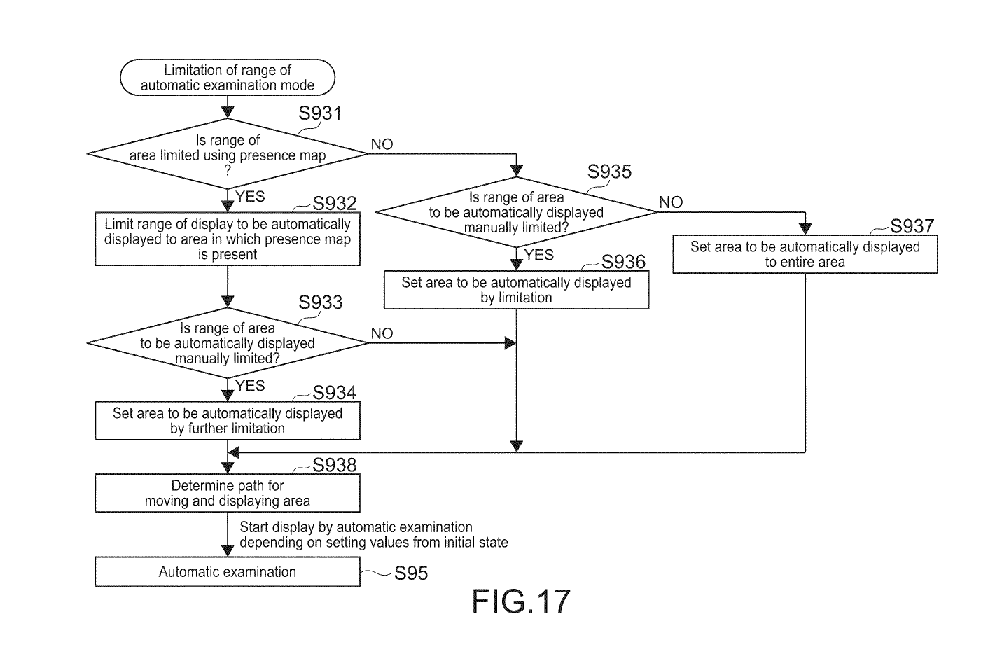

Next, the flow of the processing related to the limitation of the range of the automatic examination mode will be described. FIG. 17 is a flowchart showing the flow of the processing related to the limitation of the range of the automatic examination mode.

The flow of the processing is roughly divided into three cases, i.e., the case where the display range is limited using the presence map (YES in Step S931), the case where the display range is limited to the range designated by the user (YES in Step S935), and the case where the entire area is displayed with no limitation (NO in Step S935). In the case where the presence map is used, further, the display range can be limited to the range designated by the user (YES in Step S933).

In the respective cases, the path determination unit 54 limits the display range to the area corresponding to the presence map or the designation by the user, and sets the display range (Step S932, S936, S937, and S934).

Next, the path determination unit 54 determines the path for moving and displaying the area depending on the range set in each step (Step S938). After that, the process performed by the viewer 500 proceeds to the step of performing the automatic examination (Step S95).

The above is the flow of the processing related to the limitation of the range of the automatic examination mode.

### OTHER CONFIGURATIONS OF PRESENT DISCLOSURE

It should be noted that the present disclosure may also take the following configurations.

(1) An information processing apparatus, including:

a display processing unit configured to display, on a display unit, at least a part of a pathological image as a display area;

a setting unit configured to receive, as information necessary to move the display area so as to scan the pathological image, at least information on a position of the display area in the pathological image and information on a method of moving the display area, which are set by a user; and

an automatic shifting unit configured to sequentially move the display area based on the set information.

(2) The information processing apparatus according to (1), further including

a switching unit configured to switch between display of the pathological image in the display area sequentially moved by the automatic shifting unit and display of the pathological image in the display area selected by the user from the entire pathological image, in response to an instruction from the user.

(3) The information processing apparatus according to (1) or (2), further including:

a generation unit configured
to receive, from the user, selection of at least one pathological image corresponding to the display area, the display area being sequentially moved by the automatic shifting unit, and
to generate, as scene information, information necessary to display the selected at least one pathological image; and

a reproducing unit configured to display, on the display unit, the at least one pathological image based on the scene information, the at least one pathological image being selected by the user.

(4) The information processing apparatus according to any one of (1) to (3), further including

a path determination unit configured to determine a path for the automatic shifting unit to sequentially move the display area.

(5) The information processing apparatus according to (4), in which

the pathological image is obtained by photographing a glass slide on which a sample is placed, and

the path determination unit is configured
to obtain a presence map having probabilities that the sample is present, for respective areas being obtained by spatially dividing the pathological image, and
to determine a path for moving the display area using the presence map.

(6) The information processing apparatus according to (4), in which

the path determination unit is configured
to receive, from the user, a designation of a range in which the automatic shifting unit sequentially moves the display area, and
to determine a path for moving the display area within the designated range.

(7) The information processing apparatus according to (4), in which

the path determination unit is configured
to recognize an edge of a sample in the pathological image, and
to determine a path along the edge.

(8) An information processing method, including:

displaying, by a display processing unit, on a display unit, at least a part of a pathological image as a display area;

receiving, by a setting unit, as information necessary to move the display area so as to scan the pathological image, at least information on a position of the display area in the pathological image and information on a method of moving the display area, which are set by a user; and

sequentially moving, by an automatic shifting unit, the display area based on the set information.

(9) An information processing program that causes a computer to function as:

a display processing unit configured to display, on a display unit, at least a part of a pathological image as a display area;

a setting unit configured to receive, as information necessary to move the display area so as to scan the pathological image, at least information on a position of the display area in the pathological image and information on a method of moving the display area, which are set by a user; and

an automatic shifting unit configured to sequentially move the display area based on the set information.

The present disclosure contains subject matter related to that disclosed in Japanese Priority Patent Application JP 2012-188749 filed in the Japan Patent Office on Aug. 29, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a display processing unit configured to display, on a display unit, at least a part of a pathological image as a display area;
a setting unit configured to receive, as information necessary to move the display area so as to scan the pathological image, at least information on a position of the display area in the pathological image and information on a method of moving the display area, which are set by a user; and
an automatic shifting unit configured to sequentially move the display area based on the set information.

2. The information processing apparatus according to claim 1, further comprising
a switching unit configured to switch between display of the pathological image in the display area sequentially moved by the automatic shifting unit and display of the pathological image in the display area selected by the user from the entire pathological image, in response to an instruction from the user.

3. The information processing apparatus according to claim 1, further comprising:
a generation unit configured
to receive, from the user, selection of at least one pathological image corresponding to the display area, the display area being sequentially moved by the automatic shifting unit, and
to generate, as scene information, information necessary to display the selected at least one pathological image; and
a reproducing unit configured to display, on the display unit, the at least one pathological image based on the scene information, the at least one pathological image being selected by the user.

4. The information processing apparatus according to claim 1, further comprising
a path determination unit configured to determine a path for the automatic shifting unit to sequentially move the display area.

5. The information processing apparatus according to claim 4, wherein
the pathological image is obtained by photographing a glass slide on which a sample is placed, and
the path determination unit is configured
to obtain a presence map having probabilities that the sample is present, for respective areas being obtained by spatially dividing the pathological image, and
to determine a path for moving the display area using the presence map.

6. The information processing apparatus according to claim 4, wherein
the path determination unit is configured
to receive, from the user, a designation of a range in which the automatic shifting unit sequentially moves the display area, and
to determine a path for moving the display area within the designated range.

7. The information processing apparatus according to claim 4, wherein
the path determination unit is configured
to recognize an edge of a sample in the pathological image, and
to determine a path along the edge.

8. An information processing method, comprising:
displaying, by a display processing unit, on a display unit, at least a part of a pathological image as a display area;
receiving, by a setting unit, as information necessary to move the display area so as to scan the pathological image, at least information on a position of the display area in the pathological image and information on a method of moving the display area, which are set by a user; and
sequentially moving, by an automatic shifting unit, the display area based on the set information.

9. An information processing program that causes a computer to function as:
a display processing unit configured to display, on a display unit, at least a part of a pathological image as a display area;
a setting unit configured to receive, as information necessary to move the display area so as to scan the pathological image, at least information on a position of the display area in the pathological image and information on a method of moving the display area, which are set by a user; and
an automatic shifting unit configured to sequentially move the display area based on the set information.
